(19) United States
(12) Patent Application Publication
(10) Pub. No.: US 2012/0215734 A1
(43) Pub. Date: Aug. 23, 2012

(54) MAINTENANCE FIGURE OF MERIT SYSTEM AND METHOD FOR OBTAINING MATERIAL CONDITION OF SHIPS

(76) Inventors: Jarratt M Mowery, San Diego, CA (US); Randy D. Bennett, Hereford, AZ (US); Rick Leeker, Manassas, VA (US); Charles W. Chesterman, JR., Norfolk, VA (US)

(21) Appl. No.: 13/030,158

(22) Filed: Feb. 18, 2011

(51) Int. Cl. G06N 5/02

(52) U.S. Cl. 706/52

(57) ABSTRACT

The Maintenance Figure of Merit system of systems provides four integrated operating sub-systems: Material Condition Reporting, Master Database, Algorithm and Report Generator. The master database is capable of accepting inputs from interfaced applications and interfaced data. The algorithm is capable of operating upon the data to produce outputs that can be used to predict fleet or ship readiness.

### STATEMENT OF GOVERNMENT INTEREST

The invention described was made in the performance of official duties by one or more employees of the Department of the Navy, and thus, the invention herein may be manufactured, used or licensed by or for the Government of the United States of America for governmental purposes without the payment of any royalties thereon or therefor.

### BACKGROUND OF THE INVENTION

1. Field of the Invention

The present invention generally relates to a system and method for objectively obtaining Material Condition of one or more ships. The present invention also relates to providing metrics that can be used to develop and plan availability work packages, to report Material Condition Readiness and improve Fleet Material Readiness.

2. Description of the Related Art

The conventional process of obtaining Material Condition uses material condition information (data and metrics) to make decisions on what part of a maintenance plan should be funded, and to report Material Condition's impact on future operational use of ships. The conventional process of obtaining Material Condition is not integrated into a systematic and objective process.

Conventionally, Material Condition for a specific ship is obtained through self-assessment by ship's force and a special team or by a special team that comes aboard and conducts assessments/inspections or certifications. The methods mentioned above may be inconsistent with each other in timing, content and purpose.

Ship's force's assessments and their documentation are the results of planned maintenance requirements and un-planned maintenance requirements (watch standing observations, trouble calls, general ship wide zone inspection and messing and berthing inspection). The results of Ship's Force's assessments may be documented in the following reporting systems: Ship's Maintenance, Material, Management (3M) System, Causality Reporting System (CASREPS), Liaison Action Reporting System, Equipment Deficiency Log, Trouble Call Logs, Departure From Specification Reporting System, 8 O'clock Reports, Danger Caution Tag-Out Program, and Operational Logs. The planned and un-planned “systems” are not integrated and in some cases they are not electronic and cannot provide data.

Special teams conduct assessments and inspections or certifications to assess Material Condition or readiness, to determine work requirements, to identify problem systems, and certify Ship's Force in the operation of the equipment. The assessments and inspections are conducted for various reasons using different methods. Assessment and inspection standards are lacking in most cases or there are differences in assessment and inspection procedures. The processes followed have different collection process, data storage and format, and timeliness and periodicity. Fundamentally, there has been no objective measure or definition of Material Condition.

Metric computation and display are left to various activities and there is no central depository or standard method of computation. Material Condition reporting of significant failures is accomplished in the Casualty Reporting System. However, in the Casualty Reporting System, not all required data elements are established, data may be corrupted and many data elements are subjective in nature because of vague criteria. Maintenance data is abundant and available from a variety of sources. Data is collected for many different reasons (e.g. to determine readiness to deploy, to identify problem systems in need of management's attention, to determine corrective maintenance actions required, to validate configuration data, etc.). However, maintenance data is stored in a variety of different locations, in different formats and with different data element nomenclature.

Conventionally, availability work package development is left to various independent organizations (Platform Type Commander (TYCOMs)) that may or may not be assisted by a planning activity. Groups of ships or ship classes when designed and constructed also have developed technically based maintenance plans. Other than submarines and aircraft carriers, there is no methodology to ensure that work packages are aligned to the class maintenance plan or that after modernization was conducted on the class that the maintenance plan is revised.

Conventionally, Material Condition Readiness Reporting (i.e., the ability to capture the Material Condition of installed shipboard equipments and measure that against the ship's ability to successfully support its assigned mission) is not accomplished because there is no method of calculating material condition readiness, displaying or using these values in the development of budgets or availability work packages. The impact of conditions noted on individual components or systems cannot be understood in terms of operational capabilities or readiness. The presentation of maintenance resource requirements uses data, but the variety of data presented can lead to confusion, and the data may not be used consistently and thus undermine confidence in the maintenance resource requirements. With different collection process and data storage/format, results of assessments could not be integrated for a single ship, ships of a class or Fleet. The only method for gauging Fleet Material Readiness is to monitor the Causality Reporting System which as mentioned is subjective. Existing methods of relating material condition of equipments to the ability to perform a mission aren't able to objectively relate degradation of equipments through a structured, repeatable methodology. Historically, many sub-elements or sub-systems were separate and the non-aligned entities could not be synergistically used to develop availability work packages associated with Operational Readiness and Material Condition Readiness Reporting because there was no functional hierarchal structure as reflected by the Navy's Configuration Database Hierarchal Structure Code (HSC), no standardized Material Condition definition or method of objectively measuring the degree to which a piece of equipment or system is degraded, and no consistent metric computation and display. The lack of common, accepted measure of Material Condition has led to the inability to agree on the effect of maintenance funding on Material Condition in the fleet.

### SUMMARY OF THE INVENTION

The Maintenance Figure of Merit (MFOM) family of computer systems overcomes the shortcomings of the conventional process by providing four integrated operating sub-systems—Material Condition Reporting, Master Database, Algorithm, and Report Generator.

Material Condition Reporting may be done through the use of the Ship's Maintenance, Material, Management (3M) System, and Causality Reporting System (CASREPS), Liaison Action Reporting System, Equipment Deficiency Log, Trouble Call Logs, Departure from Specification Reporting System, 8 O'clock Reports, Danger/Caution Tag-Out Program, and Operational Logs.

A database may be created based upon naval vessels design process that has a breakdown structure that would logically group objects by functionality. This breakdown structure could be created that would meet the requirements of the Algorithm that operates on the database as well as help establish a structure for the database.

The Algorithm operates on the data in the database. The Algorithm uses the structured hierarchical system of families or consistent grouping of objects across all class of ships that lends itself to the use of a weighted average equation where the Material Condition of the parent can be calculated based upon the Material Condition of the Children as the weighted average equation takes into account the distinct relative and individual contributions of the Children as opposed to a simple average calculation.

MFOM provides Material Condition Readiness Metrics and Maintenance Metrics to support Material Condition Readiness reporting and availability work package development. Material Condition Readiness reporting may provide metric values to the Defense Readiness Reporting System (DRRS) in the required format. Work package development is the assignment of work to maintenance availability. MFOM assists the maintenance community by providing screening/prioritization recommendations for each work candidate. These recommendations can then be used to assign the maintenance item to an availability so that the overall material condition of the naval vessel is improved to support its next operational employment.

In one aspect the invention provides a maintenance figure of merit computer system that includes a master database having data. The master database is capable of accepting interfaced data from interfaced applications. The system also includes an algorithm capable of operating upon the data to produce outputs that can be used to predict fleet or ship readiness.

In another aspect the invention provides a method of determining ship readiness including the steps of collecting data gathered during various activities on a ship in a master database of a computer; analyzing the data contained in the master database using an algorithm; and outputting at least one report indicative of ship readiness.

Further features and advantages will appear more clearly on a reading of the detailed description, which is given below by way of example only and with reference to the accompanying drawings.

### BRIEF DESCRIPTION OF THE DRAWINGS

FIG. 1 is a schematic illustration of an embodiment of the maintenance figure of merit system including the inputs to and the outputs from the system.

### DETAILED DESCRIPTION

The Maintenance Figure of Merit (MFOM) system overcomes the shortcomings of the conventional process by providing four integrated operating sub-systems—Material Condition Reporting, Master Database, Algorithm, and Report Generator. In one embodiment, the MFOM system is a computer system. Operational Readiness, the ability of a ship to be ready for tasking or perform an assigned mission, is dependant on the material condition of installed shipboard equipments and systems.

MFOM system reduces infrastructure costs by utilizing existing hardware and communications software to minimize both its afloat and ashore footprints. MFOM system also reduces data duplication by linking to other existing shipboard maintenance systems as well as sharing existing databases. Additionally, MFOM system may provide the user with a “Microsoft Office” type simplicity that includes a single login and password for all shipboard maintenance programs. MFOM ship models are developed collaboratively using technical and operational Subject Matter Experts (SME). The Technical SMEs (SYSCOM, warfare centers, PYs, etc.) build the ship models from the system level down to the sub-component level. The Operational SMEs (Commanding Officers (COs), Executive Officers (XOs), Department Heads (DHs), etc.) may verify the work done by the technical SMEs and assign various systems to their related tasks, missions and warfare areas. Ship models account for redundancy and system interdependency. Model accuracy may be maintained primarily through the alteration process. The ship alteration process requires models be updated before installation/change out of new systems or components. Models are also available for review and update by ship's force.

MFOM system addresses the poor data quality issue through coordinated use of technology, software and training. Limiting the data Ship's Force or others need to enter through automation reduces variation and simplifies the training requirements. MFOM system may use a multi-faceted approach to training: school house training, computer based training, integrated computer help functionality, a 24 hour help desk and detailed user manuals. The combination of all these elements improves data quality. Associating the traditional maintenance data with readiness calculations has the added benefit of increased management attention, accuracy and detail. MFOM system is the single, authoritative, centrally managed application that provides the necessary data upgrades and improvements to support readiness and maintenance reporting.

The basic elements of MFOM system are: a standardized procedure to obtain material condition values, a repository of objects related in a structured functional hierarchal configuration model, a series of numeric algorithms to calculate material condition metrics and to sequence time or trend values.

The operation of MFOM system includes an assessment (identifies the material condition of an object, i.e., Material Condition Reporting) and storing of the results of the assessment in the MFOM Master Database. The MFOM Algorithm operates on the Master Database to create transactional metric values for which the Report Generator then produces either Material Condition Readiness Metrics for material condition reporting or Maintenance Metrics to support availability work package development.

The MFOM Model as a database is designed to support algorithms by providing information for the algorithms to operate on and store calculated metric values used to meet Readiness Reporting Requirements. The MFOM Model is composed of equipment/systems or objects organized into a functional hierarchal structure. Objects can be:

Physical—Water Tight Door

Software—Tactical or non-Tactical applications or programs

Services—Crane and Rigging or Design

Program—Safety, Environmental

Model place holders—used to provide continuity in the model structure.

The basic building block of a MFOM Model is called a Family. A Family consists of a hierarchal structure of two levels of indenture with the Parent at the upper level and two or more Children at a level of indenture immediately below. This relationship of Parent to Children is called a vertical hierarchal structure. The alignment of objects in the vertical hierarchal structure establishes the dependency relationship of an object (Parent), to the objects at a level immediately below (Children). This dependency of the Parent upon the associated Children is quantified in the MFOM Model by the use of two values called Criticality and Weighting Factor.

Criticality reflects the dependence of the Parent on the Child. Criticality is determined by the question, “can the Parent operate or function without the Child”? If the response is “no”, then the Child is labeled as a Critical Child. If the parent can operate or function without the Child then the Child is not critical. Weighting Factor allows for granularity of importance over a straight ranking scheme for the Children to one another for the same Parent at the same level of indenture. The Weighting Factor value is determined by the Operational or Technical SME. For non-critical Children, a second question is “if the Child is inoperative (EOC=0.0, Totally Inoperative) what should be the Parent's expected Operational Performance Value (Impact) be”? The Operational or Technical SME uses the Equipment Operational Capability (EOC) table described below to associate the anticipated performance to the descriptions provided in the table and records the Impact Value.

The use of families allows many objects to be grouped into larger and larger associations of objects that are called a breakdown structure. Current Navy practice has numerous schemes for describing breakdown structures and MFOM system has adopted the descriptive terms of System/Major Components, Sub-System, Component, Sub-Component and Lower Sub-Component, or Part and Piece as a description of each level of indenture of the breakdown scheme.

MFOM system's support of the Defense Readiness Reporting System, Navy (DRRS-N) requires the Model breakdown structure to incorporate the levels of indenture of Mission Area and Navy Task, where the Navy Task is a Child of Mission Area. Accordingly, the upper portion of the MFOM model starts with the highest level of indenture of Mission Area, with the next lower level of indenture the Navy Task, followed at the next level of indenture with System or Major Components. The lower portion of the MFOM Model starts with the System or Major Components level of indenture also called “L2”. The levels of indenture continue down to objects at the lowest indenture level called Lowest Level of Indenture (LLI). The relationship of Warfare or Mission Areas to Navy Task (NTA) and NTA to Systems supports a natural split between an upper and lower portion of the Model that occurs at the System or Major Components level of indenture.

The transactional metric values that the algorithm calculates are called Index Values (System or Major Component and below, NTA, Warfare Area and Activity), Screening MFOM and Regional Maintenance Center (RMC) MFOM. These values are a dimensionless number from 0.0 to 1.0. The Index Value uses the same title, value or range and description/definition as the Equipment Operational Capability (EOC). Associated with the Index Values (IV) and EOC range of values is a standard set of definitions.

| | IV | |
|---|---|---|
| Title | value or range | Description/Definition |
| Fully Operable | 1. | The object appears to be in very good |
| | | material condition, it has no evidence |
| | | of corrosion or noticeable |
| | | discrepancies. Notification created |
| | | only for Preventive Maintenance |
| | | actions or ordering parts. |
| Fully Operable with | 0.9 | The object works with only cosmetic |
| Cosmetic Discrepancies | | discrepancies, has slight corrosion. |
| | | The documented discrepancy does not |
| | | affect performance; there are no |
| | | anticipated problems or a need for |
| | | troubleshooting. |
| Fully Operable with no | 0.8 | Object works with no loss in |
| Performance impacting | | performance but has minor |
| discrepancies | | discrepancies or minimal corrosion. |
| | | Problems are anticipated or |
| | | troubleshooting is necessary. Minor |
| | | redundancy impacted with no effect |
| | | on performance. |
| Operable with minor | 0.7 | Object works with no loss in |
| discrepancies that do | | performance but has significant |
| not impact Performance | | discrepancies that need to be corrected |
| | | or monitored. One of many modes |
| | | may be inoperative. Minor corrosion. |
| Operable with | 0.6 | Object works with no current loss in |
| discrepancies that could | | performance but performance |
| potentially impact | | degradation is anticipated. Significant |
| Performance in the | | discrepancies need to be corrected or |
| future. No Restrictions | | troubleshooting initiated to prevent |
| | | performance degradation. Corrosion |
| | | could impact performance if not |
| | | corrected. |
| Operable with | 0.5 | Object is capable of performing |
| discrepancies that effect | | intended functions, but not to all |
| Performance. No | | designed performance standards, or |
| restrictions on operation. | | not capable of performing required |
| | | functions in all operating modes. |
| Restricted operation. | 0.4 | Object not operating correctly and no |
| Significant discrepancies. | | means or work around allows the |
| | | object to do everything it was |
| | | designed to perform. |
| Severely degraded with | 0.3 | Object not operating correctly or |
| major operational | | performing intended functions. Not a |
| restrictions. | | threat to personnel safety but further |
| | | equipment damage may occur from |
| | | continued operation. |
| Repair Before Operation | 0.2 | Object not functioning within |
| | | designed parameters and may only be |
| | | operated under emergency conditions. |
| Should not be | 0.1 | Object not functioning. Secure or turn |
| operated/Battle Short | | off immediately. |
| Totally Inoperative | 0.0 | Object dose not work at all. |

MFOM Index Value Calculations, System and below from its Children's' material condition is called a “roll-up”. The method of calculation of Index Values applies to the hierarchal structure starting with the Lowest Parent all the way up to the System. There are two variations within the classic roll-up calculation, Simple Weighted Average, and Modified Weighted Average.

If all Children are non-critical items—simple weighted average is used.

$$Parent Material Condition = \frac{\sum ( E O Cs ) ( Wts )}{\sum ( W T S )}$$

Where, EOCs=The Material Condition values for the Children and Wts=The Weighting Factor for the Children.
If at least one Child is critical—modified weighted average is used:

$$Parent Material Condition = \frac{L C E O C [ {Wt}_{LCEOC} + \sum ( other E O Cs ) ( other Wts ) ]}{\sum ( Wts )}$$

Where, LCEOC=The Child with the lowest material condition value (EOC).
Wts_{LCEOC}=The Weighting Factor for the Child with the lowest material condition value.
EOCs=The Material Condition values for the other Children.

### Wts=The Weighting Factor for the Children.

MFOM Index Value Calculations for System and below are used in the calculation of MFOM Index Value Calculations for NTA, Activity, Screening MFOM and RMC MFOM. The MFOM Index Values for System and below are not sent to DRRS-N, but are displayed in MFOM.

MFOM Index Value Calculations for NTAs is a Simple Weighted Average method. For a given NTA all systems are considered critical, therefore, the Simple Weighted Average method is used. These results are sent to DRRS-N.

MFOM Index Value Calculations for Warfare Area is a Simple Average as required by DRRS-N. These results are sent to DRRS-N. The current DRRS-N methodology is that each NTA's contribution to the Warfare Area is the same and that there is no differentiation or ranking of the NTAs.

MFOM Index Value Calculations for an Activity is a Weighted Average. These results are not sent to DRRS-N, but are displayed in MFOM system. To support a weighted averaging, the model building efforts prioritized Warfare Areas to Operational Scenarios which are used to reflect the use or employment of the activity. For example: Deployment, Anti Terrorism Force Protection (ATFP), Visit, Board, Search, Ballistic Missile Defense, Training, Port Visits, Testing (Post Avail). Accordingly, for a given Operational Scenario each of the associated Warfare Areas has associated with it a Weighted Value that is multiplied times the specific Warfare Area Index Value and then averaged overall.

Screening MFOM (MFOMp) is used in MFOM system to support the prioritization of Maintenance. Screening MFOM is calculated as the product of the EOC or Index Value (IV) or Future Impact Value (FI) times the Impact Value (IMP) times the War Fighting Delta (WFΔ).

MFOMₚ=(1−EOC or IV or FI)*(IMP)*(WF_{Δ})

Where, IMP=Impact Value is a value calculated by the algorithm and assigned to each object in the hierarchical structure. It is a dimensionless number between 0.0 to 1.0 that reflects the impact of a particular object on the War Fighting Area. After the hierarchal structure of the model is developed, an object EOC is set to 0.0 and all others are kept at 1.0 and the Index Value for the War Fighting Area is calculated. This process is repeated for all objects in the hierarchal structure. The IMP value remains with the object until the hierarchal structure is changed by the Ship Alteration process.

Where, WF_{Δ}=War Fighting Delta is a dimensionless value between 1 to 99 that represents the difference between the standard Index Value for a particular War Fighting Area and the calculated Index Value as reflected by WF_{Δ} times 100. This value calculated by the MFOM Algorithm allows for differentiation between objects of similar EOC and Impact Value by war fighting.

To take into account the requirement of prioritization of work at a Regional Maintenance Center for a number of ships, RMC MFOM is MFOMp times Time Accelerator (TA). The Time Accelerator is a unit value in weeks until ship is deploying on next mission.

Finally, the Maintenance Metrics are analyzed to either improve the design of the naval vessels, to decrease maintenance requirements or review the availability execution process to decrease the cost of accomplishing maintenance.

The MFOM system includes four integrated operating sub-systems—Material Condition Reporting, Master Database, Algorithm, and Report Generator. The description of MFOM including its sub-systems and the description of their operation follows.

### Material Condition Reporting

Material Condition Reporting as previously discussed is through the use of the Ship's Maintenance, Material, Management (3M) System, and Causality Reporting System (CASREPS), Liaison Action Reporting System, Equipment Deficiency Log, Trouble Call Logs, Departure from Specification Reporting System, 8 O'clock Reports, Danger/Caution Tag-Out Program, and Operational Logs. Rather than start a new reporting requirement in support of MFOM system, the above mentioned independent reporting processes are used to support the MFOM system reporting requirements. MFOM system is capable of evolving further, especially to reduce the work load relating to capturing material condition.

Currently the Ship's 3M System and CASREPS are the only reporting systems that directly feed Equipment Operation Capability (EOC) with configuration information to MFOM system. EOC may evolve to being determined by comparing objective evidence with a standard such as a design criteria or normal operating parameters for a specific configuration item or object in the structured functional hierarchical database. In the interim, until assessment procedures, test procedures and other technical documents are converted to reflect this methodology, the below logic may take information from the 3M and CASREP System and develop an EOC value. The 3M reporting is accomplished in accordance with NAVSEAINST 4790.8B Ships' Maintenance and Material Management (3-M) Manual. The specific document used is called the OPNAV 4790/2K, commonly called a “2K” or “work candidate.” A copy of Appendix A of the NAVSEA INSTRUCTION 4790.8B is included in Appendix A. The document has several blocks that contain information relative to configuration and material condition reporting actions.

The following is the interim logic used to determine the EOC value from a OPNAV 4790/2K.

### Block 4: APL/AEL (Allowance Parts List/Allowance Equipment List)

1. For equipment not listed in Consolidated Onboard Supply Allowance List (COSAL) enter “NOT LISTED.”
2. For maintenance actions which are not equipment related, such as requests for manufacture of cruise boxes, printing services, etc., enter “NA.”
If the item is NA or not listed then the 2K should not be considered for use in the model since if the item does not have an Allowed Parts List (APL) or Allowed Equipment List (AEL) it should not be considered worthy of incorporation.
ACTION: Disregard the 2K.

### Block 7: STA (Status)

1. Operational
2. Non-operational
3. Reduced capability
0. Not applicable
This is a good evaluation by the 2K writer as to the status of the equipment now which is exactly what EOC value is. ACTION: Use 1=0.8; 2=0; 3=0.6; and 0=1.0 for EOC values.

### Block 13: IDENT/EQUIPMENT SERIAL NUMBER

1. On items such as phones, fans, etc., more than one item may be listed on the same 2K as long as all other data in Section I is the same. In these cases, enter “VARIOUS” in the block.
2. Enter the abbreviation “NA” (Not Applicable) for the following:
   a. Where no specific identification or equipment serial number is given, or
   b. Photographic services, plaques, printing, cruise boxes, etc.
If “VARIOUS” is entered in this block there is no way to determine which equipment should have this EOC value and if NA is entered the item should not be considered either. ACTION: If either of these values is entered in this block then disregard the 2K.

### Block 15: SAFETY HAZZARD

1. SERIOUS SAFETY DISCREPANCY-CORRECT AS SOON AS POSSIBLE
2. SERIOUS SAFETY DISCREPANCY-SUSPENSION OF EQUIPMENT/SYSTEM/SPACE IS REQUIRED
3. SERIOUS SAFETY DISCREPANCY-WAIVER OF EQUIPMENT/SYSTEM/SPACE IS GRANTED PENDING CORRECTION OF THE ITEM
4. SAFETY ITEM-MINOR
5. COMBUSTIBLE MATERIALS
This indicates a major problem with the equipment now if this block is used with any of the first three values. The last two values have little bearing on the equipment current EOC value. ACTION: Use 1 or 2=0.0 and 3=0.6.

### Block 41: PRI (Priority)

1. MANDATORY
2. ESSENTIAL
3. HIGHLY DESIRABLE
4. DESIRABLE
Although a good indication of how the writer views the necessity of completing the job, the value does not indicate anything about the current EOC value. ACTION: Do not use this block to determine EOC value.

Other reporting systems may also be utilized to directly feed EOCs with configuration information to MFOM system. The Equipment Deficiency Log, Trouble Call Logs, Departure from Specification Reporting System, 8 O'clock Reports and Danger Caution Tag-Out Program work may be integrated in such a fashion that they will relate the material condition of an object to the configuration of the object and that this alignment in one application is available for use by another application, i.e., write one and use many times. The Operational Logs and Liaison Action Reporting System may also be integrated in the future.

### Master Database

A database may be created based upon naval vessels design process. The breakdown structure is based upon the logical grouping of objects by functionality as the vessels design process iteratively moves from conception to detail design in support of vessel's required operating conditions and projected operating environment. The database structure used must meet the requirements of the Algorithms that operate on the database as well as help establish the data structure for the database.

Systems that make up all the objects found aboard ships may be broken up into three areas for the purpose of modeling or building the functional vertical hierarchal structure: Generation (source of system product), Distribution (means to move system product) and End User (user of system product).

For most Systems all three areas will fall under the same System. However, for Critical Distributive Systems (60 Hz-120 Volt Power, 400 Hz, Power, Direct Current Power, Dry Air, High Pressure/Low Pressure/Medium Pressure Air, Steam, Chill Water, Fire/Flushing Water, Potable Water, Ventilation, etc.), as may be described in the Expanded Ship Work Breakdown Structure, the components found in the End User area are associated with the End User associated System. An example would be the chill water valves (inlet/outlet) for a ventilation cooling coil. The valves are assigned as Children of the ventilation cooling coil in the Ventilation System and are not included in the Chilled Water System.

The composition of System's boundaries may vary between the Hull, Mechanical and Electrical and the Combat Systems/Command, Control, Communications, Computers, and Intelligence (C4I) disciplines. The conventions found in the Aircraft Carrier Expanded Ship Work Breakdown Structure (ESWBS) Manual 2001 CV/CVN, as well as the conventions followed by the In-Service Engineering Agent as well as the Surface Ship Planning Yards are used to determine system's boundaries. Other suitable conventions may also be considered.

The Master Database includes MFOM Model that has the overall hierarchal structure that includes War Fighting/Mission/Naval Tasking, Functional Area, System, Sub-System, Component, Sub-Component, Lower Sub-Component, Part and Piece.
The War Fighting/Mission/Naval Tasking items may be designated by a higher authority.
The Functional Area is the means to break the ship and or submarine into functional areas in accordance with, for example, the current non-standard Expanded Ship Work Breakdown Structure (ESWBS). The sixteen areas (Auxiliary, Aviation Support and Aircraft Launch & Recovery, C4I, Damage Control, Detection, Computation and Engagement, Electro Magnetic Counter Measure, Mine Hunting, Mine Sweeping, Outfitting & Furnishings, Power Generation, Propulsion, Reactor Systems, Repair Support, Strategic Systems, and Self Defense) provide a logical functional grouping of systems and major components. For purposes of model calculations they provide no functionality.
Functional Area Templates were created for the prototype Mine Counter Measures—MCM 1 Class Model. There were fourteen functional areas and that has changed to sixteen to accommodate Carriers and Submarines. Essentially the template associates the systems and major components of systems to functional areas. Over time these templates have changed.

A family in the MFOM Model Structure is composed of a Parent and at least two or more Children. To incorporate both design and operational requirements there are three types of Families, Vertical Family, Horizontal Family and Operationally Linked Family.
Vertical Family
   A vertical family may consist of one Parent and at least two or more Children all within the same system.
   A vertical family may contain many like Children to support variable operational demands. The number of Children is dependent upon System design criteria. An example of a vertical family with many like Children is a Fire Main System with multiple pumps and zones.
Horizontal Family
   A horizontal family may consist of two or more Parents with one or more Children, in two or more systems that can be aligned (cross connected) to functionally support another Parent. An example of such a horizontal family would be Trim and Drain Pumps on a Submarine or use of AN/SPS-49 Radar when AN/SPN-43 Radar is inoperative.
   A horizontal family may also contain like Children to support variable operational demands with the number of Children depending upon the system design criteria. An example of such a horizontal family would be multiple pumps in the Fire Main System or Auxiliary Machinery Cooling Water System.
Operationally Linked Family
   An Operationally Linked Family consists of two or more Parents in the same or different systems, where the Material Condition of families is associated. An example of An Operationally Linked Family would be a Boiler and Boiler Inspection Device or TACAN and Flight Operations.

The functional hierarchal model structure is an alternative to the non-standard across all classes of ships traditional breakdown structure. The MFOM Functional Index Number (FIN) was created to provide a reference schema for the functional hierarchal model structure. The MFOM FIN is an alpha/numeric value assigned to all items in the functional hierarchal structure. The MFOM FIN has resolved issues (such as non-standardized structure across Class for the same equipment, non-standard structure across Navy, no consistent serialization for all unique objects, location value is not standardized for afloat units etc.) associated with the Hierarchal Structure Code (HSC) in the Navy's configuration database as well as provided the structure for the MFOM database.

Responsibility for the technical content of the lower portion of the model is under the purview of the Warranted Technical Authority and may be delegated to his agent (Engineering Area Manager (EAM) or Cognizant Engineer (CE)) as described in the VIRTUAL SYSCOM ENGINEERING AND TECHNICAL AUTHORITY POLICY, NAVSEAINST 5400.97 (series). Whoever is designated by the Warranted Technical Authority (Owner) is called the MFOM FIN Author. For a given object, where there are several levels of Children, it is possible that certain areas of the hierarchal structure may belong to a Warranted Technical Authority or an agent other than that of the Parent/object. In this case, the specific Child will be identified with the responsible Warranted Technical Authority or his agent. For example, the Fire Pump Assembly as a Parent has components of Fire Pump, Fire Pump Assembly and the Fire Pump Motor. The Fire Pump Assembly and Foundation belongs to Agent A, the Motor belongs to Agent B who is responsible for all Navy motors and the Fire Pump belongs to Agent C who is responsible for all Navy Pumps.

| Object | Owner | Author |
|---|---|---|
| Fire Pump | WTA | Agent A |
| Assembly | | |
| Fire Pump | WTA | Agent C |
| Fire Pump | WTA | Agent A |
| Foundation | | |
| Fire Pump Motor | WTA | Agent B |

Responsibility for the operational content of the upper portion of the model has been delegated by Commander, U.S. Fleet Forces Command to the respective TYCOMs. The TYCOM makes the linkages of the System/Major Components to NTA's for a specific Warfare Area. The assignment of NTAs to Warfare Area is accomplished and controlled in DRRS-N.

The MFOM FIN consists of three data groups: Location, Function and Identification/Serial Number and has a descriptive title, FIN Title. The MFOM FIN composition may be modified in order to meet emerging or changing requirements.

Location of the object is defined as Afloat, Ashore (Warehouse or at a Maintenance Plant) and In Transport. The Afloat Location is composed of three groups: Unit Identification Number (UIC), Compartment Number and Compartment Name. Ashore and In Transport schema may be defined as necessary.

| Title | Character | Nominal size |
|---|---|---|
| Location Afloat— | Alpha/Numeric | 6 |
| UIC | | |
| Location Afloat— | Alpha/numeric | 14 |
| Compartment Number | | |
| Location Afloat— | Alpha/numeric | 50 |
| Compartment | | |
| Name | | |

UIC is assigned to Naval activities.
Location—Compartment Number—After 1949, each compartment was given a number indicating that compartment's deck number, frame number, relation to the centerline of the ship, and usage. A hyphen separates the numbers and letters representing each type of information. The following is an example of a surface ship compartment number and what each part of the number represents:
   Deck Number-Frame Number-Centerline-Usage
   3-75-4-M
   3—third deck
   75—forward boundary at or immediately abaft of frame 75
   4—second compartment outboard of CL to port
   M—ammunition compartment
   DECK NUMBER—The main deck is deck number 1. The first deck or horizontal division below the main deck is number 2; the second below, number 3; and so forth. If a compartment extends down to the shell of the ship, the number assigned the bottom compartment is used. The first horizontal division above the main deck is number 01, the second above 02, and so on. The deck number, indicating its vertical position within the ship, becomes the first part of the compartment number.
   FRAME NUMBER—The frame number at the foremost bulkhead of the enclosing boundary of a compartment is its frame location number. When a forward boundary lies between frames, the frame number forward is used. Fractional numbers are used only when frame spacing exceeds 4 feet.
   RELATION TO CENTERLINE—Compartments through which the centerline of the ship passes carry the number 0 in the third part of the compartment number. Compartments located completely to starboard of the centerline have odd numbers; those completely to port bear even numbers. Two or more compartments that have the same deck and frame number and are entirely starboard or entirely port of the centerline have consecutively higher odd or even numbers, as the case may be. They are numbered from the centerline outboard. For example, the first compartment outboard of the centerline to starboard is 1; the second, 3; and so on. Similarly, the first compartment outboard of the centerline to port is 2; the second, 4; and so on.
   COMPARTMENT USAGE—The fourth and last part of the compartment number is a capital letter that identifies the assigned primary usage of the compartment. Since most ships do not consider a secondary usage of compartments, they identify them by a single letter only. However, dry and liquid cargo ships do not follow this practice. These ships use a double-letter identification to designate compartments assigned to cargo carrying. Ships assign letter identifications as follows:

| Code | Category | Usage |
|---|---|---|
| A | Dry stowage | Storerooms, issue rooms, |
| | | refrigerated spaces |
| C | Ship control and | Plotting rooms, CIC, radio, radar, |
| | fire control | sonar operating spaces, pilothouse |
| | operating spaces | |
| E | Engineering spaces | Main propulsion spaces; pump, |
| | | generator, and windlass rooms |
| F | Oil stowage | Fuel oil, diesel oil, and lubricating |
| | | oil tanks |
| G | Gasoline stowage | Gasoline tank compartments, |
| | | cofferdams, trunks, and pump rooms |
| J | JP-5 tanks | Aircraft fuel stowage |
| K | Chemicals and | Stowage of chemicals and |
| | dangerous materials | semi-safe and dangerous materials, |
| | | except oil and gasoline tanks |
| L | Living spaces | Berthing and messing spaces, medical |
| | | and dental areas, and passageways |
| M | Ammunition | Stowage and handling |
| Q | Spaces not | Ship's offices, laundry rooms, |
| | otherwise covered | galleys, pantries, and wiring trunks |
| T | Vertical access | |
| | trunks | |
| V | Voids | Cofferdam compartments, other than |
| | | gasoline; void wing compartments |
| W | Water stowage | Compartments storing water, including |
| | | bilge, sump, and peak tanks |
| AA, FF, | Spaces used to | |
| And GG | carry cargo. | |

Submarines conform to the standard naval compartment and tank numbering system described above in this document, but due to the smaller number and familiarity with their spaces, submariners routinely refer to compartment locations by noun name, for example: Control Room. If a space has more than one level, level is included in the noun name, for example: Engine Room Upper Level. Submarines also, refer the equipment location by space name and usage name, for example: Engine room Lower Level, Condensate Bay. A bay is usually a space in a compartment divided by a partial bulkhead, non-water tight. This particular bay is the bay where the condensate pumps are located.
Location-Compartment Name—Compartment Name is a 50 alpha character set that identifies the primary function of the compartment.

Function defines the operational contribution, action, purpose or activity of an object. As an object is part of a system, it is defined by the pedigree. The following Title/Tag elements and nominal size define the character: Functional Area, System, Sub-System, Component, Component Type, Sub-Component, Lower Sub-Component, Part and Piece.

| Title | Character | Nominal size |
|---|---|---|
| Functional Area | Alpha | 1 |
| System | Alpha/numeric | 2 |
| Sub-System | Alpha/numeric | 2 |
| Component | Alpha/numeric | 3 |
| Sub-Component | Alpha/numeric | 3 |
| Lower Sub-Component | Alpha/numeric | 3 |
| Part | Alpha/numeric | 3 |
| Piece | Alpha/numeric | 3 |
| FIN Title | Alpha/numeric | 50 |

To support recognition of an object there are several assigned attributes: Traditional System Designator, Component Type and Variant.
Traditional System Designator—The Ships Work List Item Number (SWLIN) designation from the associated HSC for all objects. Where there is no assigned HSC, then an approved SWLIN will be used.
Component Type—Describes the Group and Class of the object. The component type identifies a specific function of an object for which the object was designed. For example the object is a “valve” and the function is “Bulkhead Isolation” in the system. The Component Type is an alpha/numeric value that identifies the object and function.
Variant—For a specific object, the designation of something that is different from the others of the same type.

| Title | Character | Nominal size |
|---|---|---|
| Traditional System | Numeric | 3 |
| Designator | | |
| Component Type | Alpha/numeric | 4 |
| Variant | Alpha/numeric | 1 |

FIN Title is associated with every object and describes the functional character of the object. The FIN Title may be composed of four elements; Function—What the object does functionally, Object—Component Type the object is, Serial Number—Serialization of the object, or Location—Where the object is physically located.

Example of FIN Title (Surface Ship): Fire Pump No. 2
Function: Fire Fighting
Object: Pump
Serial Number: 1 or 2
Location: Fire Room

Example of FIN Title (Submarine): AUX Sea Water Pump No. 3
Function: Auxiliary Seawater
Object: Pump
Serial Number: 1 or 2, 3
Location: Engine room Lower Level, ASW Bay

Example of FIN Title (Combat Systems): Navigation WSN-7 FWD
Function: Electronic Navigation
Object: AN/WSN-7
Serial Number:
Location: Forward or Aft

Identification/Serial Number applies a unique identifier to an object. The identifier can be composed two different ways, using the (Item Unique Identifier) IUID or Material Identification Number (MID). The following table defines the character of Identification/Serial Number.

| Title | Character | Nominal size |
|---|---|---|
| IUID | Alpha/numeric | 50 |
| Material | Alpha/numeric | 50 |
| Identification | | |
| Number | | |

The IUID or MID as unique values also help establish the uniqueness of the Equipment Record were equipment specific information, material condition history and previous use of the equipment will be stored. Recognizing that current material history is only captured for the location of the object and does not move as equipments move, the use of the IUID or MID and the associated Equipment Record will significantly change the metric values associated with objects.

Modeling rules listed below ensure that the resultant structure of the MFOM Master Database is operable on by the algorithm.
Structure model are objects, physical (Water Tight Door, etc.), software (Microsoft Access Program, etc.) and model place holder (place holder in the model structure) not checklists or test results.
Weights for critical items must be the same.
Single Child Parents are unnecessary.
Parents with only critical offspring can be simplified by changing the parent to a Child by itself with no Children, unless the granularity is needed for analysis.
Each Child directly impacts its parent. Therefore, Children are not at the same level of indenture as their parents.
At a system level, Children should impact only one parent.
For analysis purposes, it's acceptable to create parents (model place holder objects) such as “Propulsion)”, “Propulsion2”.
Redundant items must be at the same level.
Objects at the same level that are redundant must be identified (redundant (Y)) and an indication of what object the redundancy is associated with (use letters to show the redundancy). For example, for a particular system there are 3 pumps that are the first redundancy they are marked with the letter (A for instance); the next redundant items in the system will all be B's etc.
Conditional statements provide amplifying information that expands the capability of the MFOM Algorithm to accommodate requirements beyond the traditional parent/Child relationship. By describing these special impacts on the parent due to a change in material condition of the Children these amplifying statements enable the MFOM Algorithm to respond. All redundant items require a conditional statement. An example, a particular system has 3 pumps. The system design requirement is two pumps with EOC equal or greater than 0.7 and if two pumps have and EOC less than 0.7 the system operational performance expectation is zero. The conditional statement for each of the pumps would be “2 pumps need with EOC= or >0.7 to be operational or parent=0”.
Distributed systems like Hydraulics, Chill Water, Ventilation, Electrical will reflect:
   a compartment isolation approach.
   a Fire Zone approach for Aircraft Carriers.
For Standard Horizontal and Operationally Linked Families:
   The input from another Family is structured as a Child of the Alternate Parent.
   The output from a Family is for only one Child.
   The output from a Family can be the input to many Families. No output from higher or lower levels of indenture of receiving Families can return back to the original family (prevents infinite loop).

The initial MFOM Model Building Process may consist of several phases described hereafter. The initial MFOM Model Building Process may include more or less phases. The maintenance of the ship specific models to accommodate configuration correction and ship alteration may follow Phase I through Phase III described below.
Phase I—
   Respective In-Service Engineering Agent (ISEA) establishes a component or system functional hierarchal structure. Boundary conditions, redundancy and other special conditions are determined. Creates ISEA Templates of common equipment.
   Respective Planning Yard (PY) maps respective systems functional hierarchal structure to functional areas. Each ship class model use the Functional Area Templates originally developed for the MCM Class Prototype Model. Modifies and updates the Functional Area Templates. Boundary conditions, redundancy and other special conditions are determined.
   Respective Planning Agent (In-Service Engineering Agent (ISEA) or Planning Activity (PA)) takes a parsed file from the Configuration Data Managers Database—Open architecture (CDMD-OA) Class Functional File (CFF) maps the respective CDMD-OA objects to the component or system functional hierarchal structure.
   Respective Planning Activity (Carrier Planning Activity, SUBMEPP) uses Functional Area Templates and excerpts from the Navy's Configuration Data Base of Record to build hierarchal structures. Boundary conditions, redundancy and other special conditions are determined. Parsed file from the CDMD-OA Class Functional File (CFF) maps the respective CDMD-OA objects to the component or system functional hierarchal structure.
Phase II—Review of model structure with respect to Functional Area Template or ISEA Templates. Determination and reconciliation of duplicate items or items left out of structure.
Phase III—Operators (current and former Commanding Officers) mapping Operational Performance Value of War fighting Area or other designated mission/task areas to the System or Major Components for an operational scenarios.
Phase IV—Verification of individual ship models and programming of model structure by Naval Surface Warfare Center (NSWC) Corona.
Phase V—Testing of ship class model and validating results against boundary conditions/operational performance values through out all levels of indenture. This is also the User Acceptance Testing of application software.
Phase VI—Loading of ship model data base with specific ship Current Ship Maintenance Project (CSMP) and unit testing.

The MFOM Master Database accordingly is a relational structured functional hierarchical database that supports the algorithm's calculations as well as report generation. Associated with every object (physical (Water Tight Door, etc.), software (Microsoft Access Program, etc.) and model place holder (place holder in the model structure)) is transactional data or historical data stored against it. This data is organized in what is called the Equipment Record, which uses the unique value of the IUID or MID to make a one to one relationship between the object and the Equipment Record. Also associated with the object are equipment specific information, material condition history, previous use of the equipment and values such as Index Values, EOCs-over time, Weights, Criticality, Redundancy and Conditional Statements.

### Algorithm

Simulation of the material condition of a naval vessel requires one or more algorithms to provide transactional metric values that will be used by MFOM system to provide Material Condition Readiness Metrics and Maintenance Metrics.

Calculations of Index Values are accomplished using Simple Weighted Average, Modified Weighted Average, Weighted Average and Simple Average.
Simple Weighted Average is used to calculate Index Values from the Lowest Parent all the way up to the System/Major Component. Paragraph 30 above describes the values used. These values are used in the calculation of Material Condition Readiness Metrics and Maintenance Metrics.
Modified Weighted Average is used to calculate Index Values from the Lowest Parent all the way up to the System/Major Component. Paragraph 30 above also describes the values used. These values are used in the calculation of Material Condition Readiness Metrics and Maintenance Metrics.
Weighted Average is used to calculate Index Values for NTAs. Paragraph 31 above describes the values used. These Material Condition Readiness Metric values are passed to DRRS-N.
Simple Average is used to calculate Index Values for Warfare Area. Paragraph 32 above describes the values used. These Material Condition Readiness Metric values are passed to DRRS-N.
Weighted Average is used to calculate Index Values for Activity. Paragraph 33 above describes the values used. These Material Condition Readiness Metric values are passed to DRRS-N

Calculations of Maintenance Metrics values (Screening MFOM and RMC MFOM) have there own specific algorithm as described previously in Paragraph 34 and 35.

For a given object there may be instances where there may be more than one EOC value associated with the object as there are multiple reporting systems, and assessments of equipment can be done independently. The Algorithm uses the pedigree of source and chronology to determine the lowest EOC value to use.

### Report Generator

Reports provide information to support the user. For example, MFOM system currently provides Material Condition Readiness Metrics and Maintenance Metrics to support availability work package development. Some values are displayed in MFOM system in various, crisp, easily understand formats that support the chain of command from Office of the Chief of Naval Operations (OPNAV) to the Sailor on the ship. Other values are exported.

MFOM system feeds equipment Material Condition Readiness Metrics information to the Defense Readiness Reporting System-Navy (DRRS-N). As a readiness reporting tool for equipment, MFOM calculates a Material Condition value (Naval Task Index Value) that can be compared to specific thresholds or requirements to determine if the ship's equipment and systems are in an acceptable material condition to support the specified assignment. This value is determined using the reported material condition, the equipment/system impact (Index Value) from the model, and the scenario (mission/task). The current Material Condition value affords the ship and its chain of command the information necessary to determine if a given ship or a group of ships are capable of performing a specified assignment and if not, what maintenance actions must be done to make them ready along with the estimated cost of those actions. Secondly, MFOM system provides a comparison tool for leadership to use in evaluating similar ships for assignment to a specific scenario, allowing them to select the best available fit. Finally, the MFOM system calculated Material Condition value is supplied to the Defense Readiness Reporting System-Navy (DRRS-N). DRRS-N requires each resource category in DRRS to provide an integer 0≦x≦100 and color (red, yellow, or green) reflecting the equipment material condition supporting Major Combat Operation (MCO) assigned to each unit. MFOM system directly feeds these two indicators to DRRS-N. MFOM system employs three colors as required by DRRS-N in association with each of the equipment material condition (MET) indicators. The “green” indicator means the unit can accomplish the task to prescribed standards and conditions with its equipment in the current condition. The “green” indicator always denotes the highest state of material condition readiness. The integers 80-100 are indicated in green. The “yellow” indicator means the unit can accomplish the task to the prescribed standards and conditions but a portion of the unit's equipment is impaired and therefore might carry some risk. The “yellow” indicator is still a “go”—and it sends leadership the signal that the unit's equipment is expected to accomplish the task to standard, under most conditions, but not all required equipment is fully operational. The yellow indicator always denotes an equipment material condition below green and above red. The integers 60-79 are reflected in yellow. The “red” indicator means the unit is unable to accomplish the task to prescribed standards and conditions due to inoperable equipment. The value associated with this threshold (0-59) should be clearly supportable by observed and evaluated values. The red indicator always denotes the lowest equipment material condition.

Work package development is the assignment of maintenance item/2K/work candidate to a maintenance availability and to a specific maintenance activity. MFOM system assists the maintenance community by providing MFOM Screening values and recommended availability that will improve the overall Readiness of the vessel. The process of work package development starts with the generation of a maintenance item as the result of an Inspection, Assessment or Planned Maintenance and this information being provided to MFOM system. Associated with the maintenance item is an EOC and configuration information of the object. The MFOM Algorithm starts to calculate Index Values from the object up to and including the Warfare Area as well as the Screening MFOM (the lower the MFOM Screening value the more important it is to correct the material discrepancy) and RMC MFOM values. MFOM system displays the maintenance item the associated metrics values. Manipulation of choices on maintenance items with respect to maintenance availabilities allows MFOM to accomplish more calculations so that the overall material condition of the naval vessel is improved to support its next operational employment.

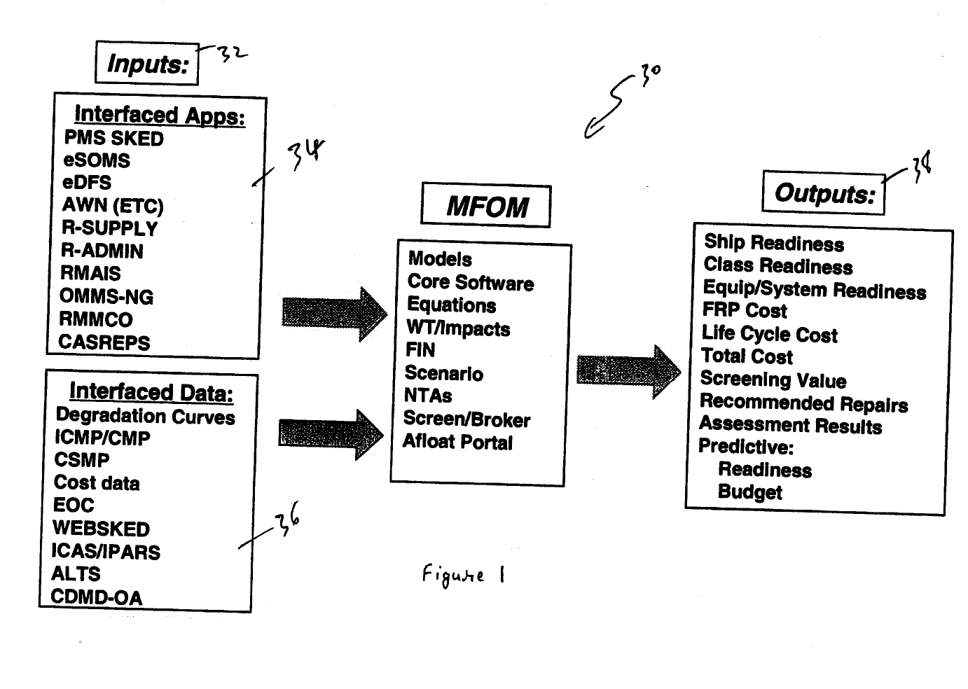

FIG. 1 shows a schematic illustration of an embodiment of an MFOM System 30. The MFOM System 30 includes Models, Core Software, Equations, WT/Impacts, FIN, Scenario, NTAs, Screen/Broker and Afloat Portal. The MFOM System 30 may accept various inputs 32. Inputs 32 are single or multiple data elements labeled as the Interfaced Data 36 (for example, Degradation Curves, ICMP/CMP, CSMP, Cost Data, EOC, WEBSKED, ICAS/IPARS, ALTS and CDMD-OA). The Inputs 32 are provided by the Interfaced Applications 34 (for example, PMS SKED, eSOMS, eDFS, AWN(ETC), R-SUPPLY, R-ADMIN, RMAIS, OMMS-NG, RMMCO and CASREPS). The data that the Interfaced Applications 34 provided is stored in the MFOM Model database in the MFOM System 30. The data is acted upon by the MFOM Algorithm contained in the MFOM System 30 to produce transactional metric values that are stored in the MFOM Model database in the MFOM System 30. The Outputs 38 may include Ship Readiness Report, Class Readiness Report, Equipment/System Readiness Report, FRP Cost Report, Life Cycle Cost Report, Total Cost Report, Screening Value, Recommended Repairs and Assessment Results. The outputs may be used to predict fleet/ship Readiness and future budget needs.

While a preferred embodiment of the invention has been described, various modifications will be apparent to one skilled in the art in light of this disclosure and are intended to fall within the scope of the appended claims.

1. A maintenance figure of merit computer system comprising:
a master database having data, the master database being capable of accepting interfaced data from interfaced applications; and
an algorithm capable of operating upon the data to produce outputs that can be used to predict fleet or ship readiness.

2. The system of claim 1, wherein the interfaced applications include eSOMS, eDFS, AWN(ETC), R-SUPPLY, R-ADMIN, RMAIS, OMMS-NG, RMMCO and CASREPS.

3. The system of claim 1, wherein the interfaced data is includes under the titled grouping of data of ICMP/CMP, CSMP, cost data, EOC, WEBSKED, ICAS/IPARS, ALTS and CDMD-OA.

4. The system of claim 1, wherein the outputs include Ship Readiness Report, Class Readiness Report, Equipment/System Readiness Report, FRP Cost Report, Life Cycle Cost Report, Total Cost Report, Screening Value, Recommended Repairs and Assessment Results.

5. A method of determining ship readiness comprising:
collecting data gathered during various activities on a ship in a master database of a computer system;
analyzing the data contained in the master database using an algorithm; and
outputting at least one report indicative of ship readiness.

6. The method of claim 5, further comprising the step of interfacing the master database with various applications on the ship.

7. The method of claim 6, wherein the applications include eSOMS, eDFS, AWN(ETC), R-SUPPLY, R-ADMIN, RMAIS, OMMS-NG, RMMCO and CASREPS.

8. The method of claim 5, wherein the data includes ICMP/CMP, CSMP, cost data, EOC, WEBSKED, ICAS/IPARS, ALTS and CDMD-OA.
